(19) United States
(12) Patent Application Publication
(10) Pub. No.: US 2020/0083918 A1
(43) Pub. Date: Mar. 12, 2020

(54) INTERFERENCE DETECTION APPARATUS

(71) Applicant: MITSUBISHI ELECTRIC CORPORATION, Tokyo (JP)

(72) Inventors: Yuji MIYAKE, Tokyo (JP); Tetsuya AOYAMA, Tokyo (JP)

(73) Assignee: MITSUBISHI ELECTRIC CORPORATION, Tokyo (JP)

(21) Appl. No.: 16/486,276

(22) PCT Filed: Feb. 27, 2017
(86) PCT No.: PCT/JP2017/007330

§ 371 Date: Aug. 15, 2019

(51) Int. Cl. H04B 1/10; H04W 4/38

(52) U.S. Cl. CPC H04B 1/1027; H04W 4/38

(57) ABSTRACT

An interference detection apparatus in a wireless system that includes a plurality of wireless sensors that transmits sensor information wirelessly and a wireless signal measurement apparatus that measures power of a wireless signal of a frequency used by the wireless sensors for transmitting the sensor information. The interference detection apparatus includes an information processor; an interference position detector; and an interference avoidance method decider. The information processor determines a lack in reception of the sensor information transmitted from each of the wireless sensors. The interference position detector acquires a histogram that is created for a predetermined power measurement period and indicates time occupancy in the power measurement period of each of classes of classified power values. The interference avoidance method decider records occurrence of interference for each power measurement period in time series on the basis of a result of detection of occurrence of interference in the interference position detector.

### FIELD

The present invention relates to an interference detection technique in a wireless communication system using an unlicensed band.

### BACKGROUND

A wireless sensor system which includes a large number of wireless sensors installed therein is drawing attention. Each of the wireless sensors includes a sensor and a wireless device that are integrated. The wireless sensor system performs: monitoring by sensors; analysis of monitoring results; prediction based on the analysis results; and the like. In such a wireless sensor system, use of an unlicensed band for wireless communication has been studied. Although a wireless device using an unlicensed band can be installed freely, it may cause radio interference with another wireless device using the same radio frequency band. For this reason, in a wireless device using an unlicensed band, a communication method for performing carrier sensing such as carrier sense multiple access with collision avoidance (CSMA/CA) is adopted.

In CSMA/CA, when a device detects a carrier of another device, transmission from the device is stopped. Therefore, in a case where a number of wireless devices using the same radio frequency band are installed in close proximity, an exposed node problem occurs in which when a device detects a wireless signal in communication between other wireless devices, the device cannot communicate with a wireless device other than the wireless devices. When the exposed node problem occurs in a situation in which there are wireless devices of a plurality of wireless sensor systems, the amount of communication in a wireless sensor system is reduced by an influence of other wireless sensor system.

As a technique for estimating the amount of interference of a wireless communication terminal affected by the exposed node problem, a method is proposed in which on the basis of transmission standby time of a wireless communication terminal which is an exposed node and transmission standby time of a wireless communication terminal which is not an exposed node, the amount of interference is estimated from a difference therebetween. (Patent Literature 1)

### CITATION LIST

### Patent Literature

Patent Literature 1: Japanese Patent Application Laid-open No. 2007-235533

### SUMMARY

### Technical Problem

However, in the above-described conventional method of estimating the amount of interference, it is not possible to estimate time-series transition of the amount of interference, so that the above-described conventional method cannot be applied when determining an interference avoidance method in consideration of time-series transition of occurrence of interference, which is a problem.

The present invention has been made in order to solve the above-described problem, and an object thereof is to realize radio wave monitoring capable of detecting time-series transition of interference.

### Solution to Problem

According to the present invention, an interference detection apparatus in a wireless system that comprises a plurality of wireless sensors that transmits sensor information wirelessly and a wireless signal measurement apparatus that measures power of a wireless signal of a frequency used by the wireless sensors for transmitting the sensor information, the interference detection apparatus comprises: an information processor to determine a lack in reception of the sensor information transmitted from each of the wireless sensors; an interference position detector to acquire, from the wireless signal measurement apparatus, a histogram that is created for a predetermined power measurement period on a basis of a result of the measurement and indicates time occupancy in the power measurement period of each of classes of classified power values, the number of which is prescribed, to compare the acquired histogram with a histogram acquired in past, and to detect occurrence of interference around the wireless signal measurement apparatus; and an interference avoidance method decider to record occurrence of interference for each power measurement period in time series on a basis of a result of detection of occurrence of interference in the interference position detector, and to determine an interference avoidance method on a basis of the record.

According to the present invention, a wireless signal measurement apparatus comprises: an antenna; a wireless interface to perform a reception process of a wireless signal received by the antenna, and to perform a transmission process of a wireless signal transmitted from the antenna; and a received power statistics collector to measure power of a reception signal of a frequency used by the wireless sensor for transmitting sensor information, the reception signal having been subjected to a reception process by the wireless interface, to create, on a basis of a result of the measurement, a histogram that indicates time occupancy in a predetermined power measurement period of each of classes of classified power values, the number of classes being prescribed, and to transmit the created histogram via the wireless interface.

### Advantageous Effects of Invention

According to the present invention, in a wireless sensor information collecting system using an unlicensed band, it is possible to detect time-series features of occurrence of interference, and to determine an interference avoidance method in accordance with the detected features.

### BRIEF DESCRIPTION OF DRAWINGS

FIG. 1 is a block diagram illustrating an example of a functional configuration of an interference detection apparatus according to a first embodiment of the present invention.

FIG. 2 is a block diagram illustrating an example of a hardware configuration of the interference detection apparatus according to the first embodiment of the present invention.

FIG. 3 is a block diagram illustrating an example of a functional configuration of a wireless signal measurement apparatus according to the first embodiment of the present invention.

FIG. 4 is a block diagram illustrating an example of a hardware configuration of the wireless signal measurement apparatus according to the first embodiment of the present invention.

FIG. 5 is a block diagram illustrating an example of a configuration of a wireless system according to the first embodiment of the present invention.

FIG. 6 is a graph illustrating an example of a histogram in the first embodiment of the present invention.

FIG. 7 is a flowchart illustrating an example of a process flow of the interference detection apparatus of the first embodiment of the present invention.

FIG. 8 is a flowchart illustrating an example of a process flow of the interference detection apparatus of the first embodiment of the present invention.

FIG. 9 is a comparison table illustrating an example of histogram comparison in the interference detection apparatus of the first embodiment of the present invention.

FIG. 10 is a flowchart illustrating an example of a process flow of the interference detection apparatus of the first embodiment of the present invention.

FIG. 11 is a table illustrating an example of recorded contents of an interference avoidance database of the interference detection apparatus of the first embodiment of the present invention.

FIG. 12 is a comparison table illustrating an example of histogram comparison in the interference detection apparatus of the first embodiment of the present invention.

FIG. 13 is a flowchart illustrating an example of a process flow of the interference detection apparatus of the first embodiment of the present invention.

FIG. 14 is a table illustrating an example of recorded contents of the interference avoidance database of the interference detection apparatus of the first embodiment of the present invention.

### DESCRIPTION OF EMBODIMENTS

Hereinafter, an embodiment of the present invention will be described in detail with reference to the drawings. The present invention is not limited to the embodiment. In the drawings to be referred to in the following description, the same or corresponding parts are denoted by the same reference numerals.

### First Embodiment

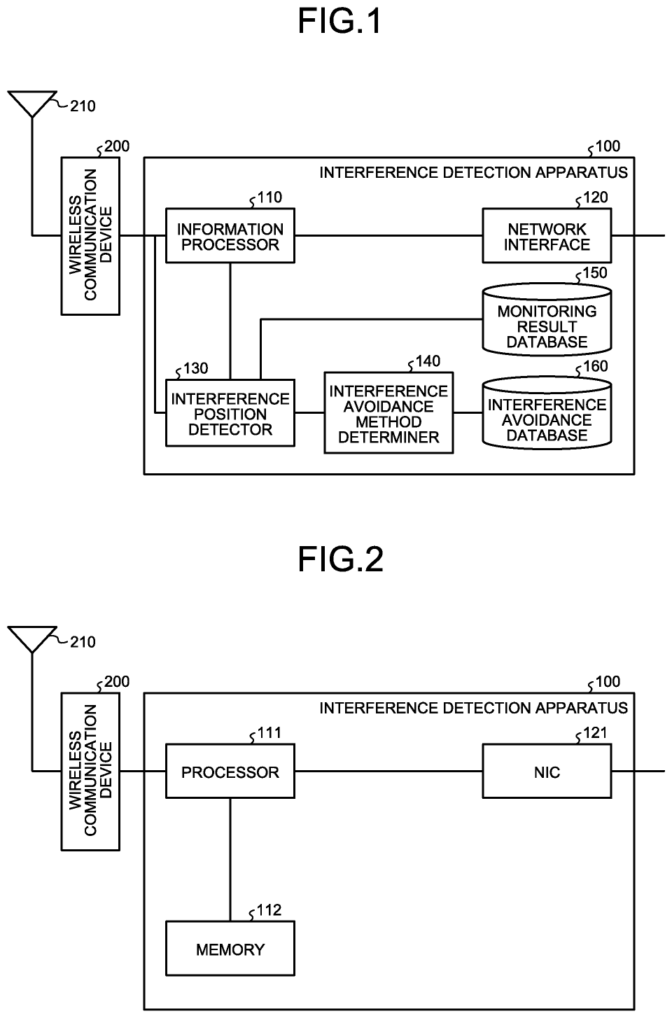

FIG. 1 is a block diagram illustrating an example of a functional configuration of an interference detection apparatus 100 according to a first embodiment of the present invention. The interference detection apparatus 100 includes an information processor 110, a network interface 120, an interference position detector 130, an interference avoidance method determiner 140, a monitoring result database 150, and an interference avoidance database 160. The interference detection apparatus 100 is connected to a wireless communication device 200, and performs wireless communication with a plurality of wireless signal measurement apparatuses 300 and a plurality of wireless sensors described later via the wireless communication device 200. Here, the wireless sensor is a sensor having a function of wirelessly notifying acquired sensor information. An antenna 210 is an antenna connected to the wireless communication device 200.

On the basis of reception data received from the wireless sensor via the wireless communication device 200, the information processor 110 determines whether pieces of sensor information the number of which is designated have been acquired, and notifies the interference position detector 130 of a result of the determination. On the basis of information: on an interference detection result received from the wireless signal measurement apparatus 300 via the wireless communication device 200; information input from the information processor 110; and history information on the interference detection result of the wireless signal measurement apparatus 300 stored in the monitoring result database 150, the interference position detector 130: detects a position of an interference system serving as an interference source; notifies the interference avoidance method determiner 140 of a result of the detection; and stores the received interference detection result in the monitoring result database 150 to update the monitoring result database 150. On the basis of the interference detection result input from the interference position detector 130 and a radio wave monitoring result stored in the monitoring result database 150, the interference avoidance method determiner 140: determines the presence or absence of a time feature of interference detection; determines an interference avoidance method; and stores a result of the determination in the interference avoidance database 160 to update the interference avoidance database 160. The network interface 120 is an interface that transmits the reception data received from the wireless sensor acquired by the information processor 110 to a sensor information collecting server in a network (not illustrated). This interface may be a wired or wireless one.

FIG. 2 is a block diagram illustrating an example of a hardware configuration of the interference detection apparatus 100. The interference detection apparatus 100 includes a processor 111, a memory 112, and a network interface card (NIC) 121. The information processor 110, the interference position detector 130, and the interference avoidance method determiner 140 may be implemented by the processor 111 and a program stored in the memory 112 and executed on the processor 111. The network interface 120 may be realized by the NIC 121. The monitoring result database 150 and the interference avoidance database 160 can be implemented by the memory 112. As the memory 112, a volatile memory or a non-volatile memory may be used depending on information to be stored. As an interface between the processor 111 and the wireless communication device 200, a dedicated interface or various existing interfaces may be used.

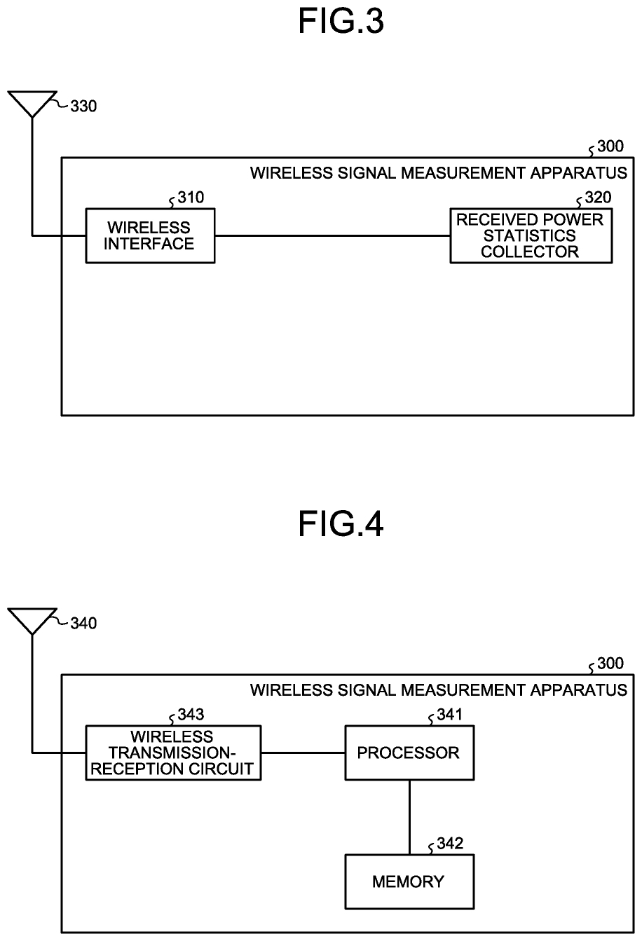

FIG. 3 is a block diagram illustrating an example of a functional configuration of the wireless signal measurement apparatus 300 according to the embodiment. The wireless signal measurement apparatus 300 includes a wireless interface 310, a received power statistics collector 320, and an antenna 330. The wireless interface 310 is an interface for performing wireless communication with another device via the antenna 330, and provides functions necessary for general wireless communication such as: a frequency conversion function; an analog-to-digital conversion function; a modulation-demodulation function; and a coding-decoding function. The received power statistics collector 320 measures power of a wireless signal received by the wireless interface 310 at a designated timing in a designated period, takes statistics of measurement results, and transmits a statistical result of the received power to the above-described interference detection apparatus 100 via the wireless interface 310.

FIG. 4 is a block diagram illustrating an example of a hardware configuration of the wireless signal measurement apparatus 300 that includes a processor 341, a memory 342, a wireless transmission-reception circuit 343, and an antenna 340. The antenna 340 is hardware corresponding to the antenna 330. The wireless transmission-reception circuit 343 is hardware corresponding to the wireless interface 310, and may be implemented by a dedicated circuit. The processor 341 and the memory 342 are hardware corresponding to the received power statistics collector 320, and the received power statistics collector 320 may be implemented by the processor 341 and a program stored in the memory 342 and executed by the processor 341. The functions of the wireless interface 310 may be partially realized by the program.

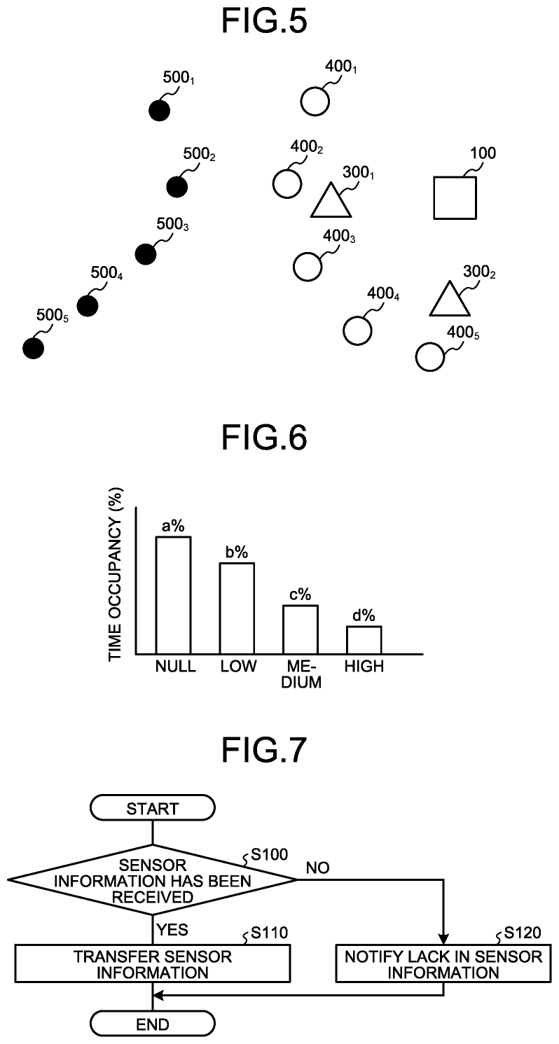

Next, operations of the wireless signal measurement apparatus 300 and the interference detection apparatus 100 will be described. FIG. 5 is a schematic diagram illustrating an arrangement example of the interference detection apparatus 100 and the wireless signal measurement apparatuses 300 (300₁ and 300₂). FIG. 5 further illustrates wireless sensors 400 (400₁ to 400₅) and wireless sensors 500 (500₁ to 500₅). Here, the wireless sensors 400 are each a device of a wireless system to which the interference detection apparatus 100 and the wireless signal measurement apparatuses 300 belong, and the wireless sensors 500 are each a device of another system. In FIG. 5, the wireless communication device 200 connected to the interference detection apparatus 100, and the antenna 210 are not illustrated. FIG. 5 is an example, and the number and arrangement of the respective devices are not limited to the example illustrated in FIG. 5.

First, an operation of the wireless signal measurement apparatus 300 will be described. The antenna of the wireless signal measurement apparatus 300 receives a wireless signal of a frequency used by the wireless sensor 400 of the wireless system to which the wireless signal measurement apparatus 300 belongs. The wireless interface 310 performs processes necessary for the wireless signal reception as described above on a reception signal of the antenna 340, and outputs the processed signal to the interference power statistics collector 320. The interference power statistics collector 320 measures received power of the input signal, and creates a histogram indicating time occupancy for each received power value for each power measurement period designated in advance. The power measurement period may be designated by the interference detection apparatus 100 by wireless communication with the interference detection apparatus 100. When time for the wireless sensor 400 to transmit sensor information is determined, the measurement of the power and the creation of the histogram may be performed in line with the time.

FIG. 6 is an example of a histogram to be created. In the example illustrated in FIG. 6, received power values are divided into four classes, i.e., high, medium, low, and null. The number of classes into which the received power values are divided and a range of each class may be determined in advance, or may be set from the interference detection apparatus 100. When a ratio of each class is added in FIG. 6, the sum will be 100. That is, a+b+c+d=100. The interference power statistics collector 320 outputs information on the created histogram after the end of the designated period to the wireless interface 310, and this information is wirelessly transmitted from the antenna 330 to the interference detection apparatus 100. Each wireless signal measurement apparatus 300 in the system performs an operation identical to the above operation.

Next, an operation of the interference detection apparatus 100 will be described. The antenna 210 receives a wireless signal including sensor information transmitted by the wireless sensor 400 of the system to which the antenna 210 belongs and a wireless signal including information on the above-described histogram transmitted by the wireless signal measurement apparatus 300, and outputs the wireless signals to the wireless communication device 200. The wireless communication device 200 inputs, to the interference detection apparatus 100, reception signals obtained by performing necessary reception processes for the received wireless signals. The reception signal received from the wireless sensor 400 is input to the information processor 110, the reception signal received from the wireless signal measurement apparatus 300 is input to the interference position detector 130, and the interference detection apparatus 100 performs processes described below.

FIG. 7 is a flowchart illustrating an example of a process flow performed by the information processor 110 of the interference detection apparatus 100. The information processor 110 determines whether sensor information has been received from the wireless sensor 400 during a predetermined sensor information transmission period of the wireless sensor 400 (S100). In a case where the sensor information has been received, the information processor 110 transfers the sensor information to a server apparatus that stores sensor information (not illustrated) via the network interface 120 (S110). Although the transfer to the server apparatus is performed here, another process may be performed. In a case where the sensor information has not been received in the process of S100, the interference position detector 130 is notified that there exists a lack in the reception of the sensor information from the target wireless sensor 400 (S120).

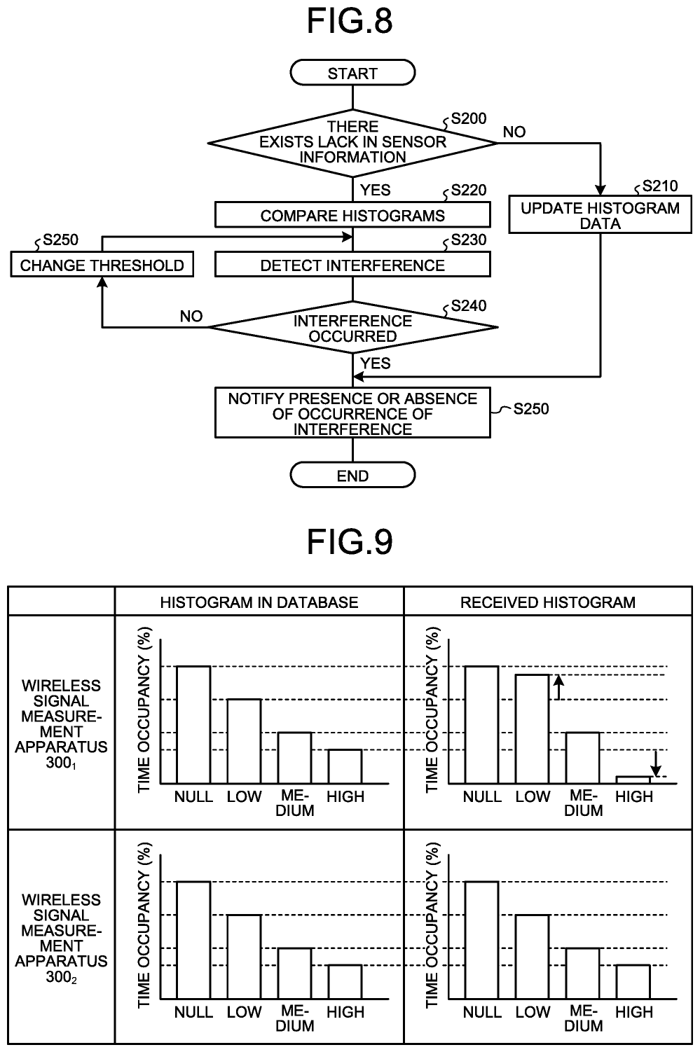

FIG. 8 is a flowchart illustrating an example of a process flow of the interference position detector 130 of the interference detection apparatus 100. The interference position detector 130 determines the presence or absence of a lack in sensor information on the basis of the notification received from the information processor 110 (S200). In a case where there exists no lack in the sensor information, the interference position detector 130 stores histogram information received from the wireless signal measurement apparatus 300 in the monitoring result database 150 to update the monitoring result database 150 (S210). The histogram information is stored in the monitoring result database 150 in units corresponding to a collection cycle of the sensor information. For example, in a case where the collection cycle is on a one-hour basis, the histogram information is stored separately every hour. Alternatively, the types of units used for the storage, the units being larger than the collection cycle such as storage performed on each day of the week, may be increased. When the received histogram information is stored in the monitoring result database 150, a method of overwriting already stored information or a method of performing multiplication by a predetermined forgetting coefficient and averaging may be possible.

When it is determined in the process of 5200 that there exists a lack, the interference position detector 130 uses the received histogram information and the histogram information accumulated in the monitoring result database 150 to compare both histograms for each wireless signal measurement apparatus 300 and acquires a similarity (S220). For the comparison of the histograms, Euclidean distance comparison, cosine similarity comparison, or cross comparison may be used, for example. The comparison of the histograms is performed for each wireless signal measurement apparatus 300. In a case where the acquired similarity falls below a predetermined threshold (similarity threshold), it is determined that interference has occurred and the exposed node problem has occurred around the corresponding wireless signal measurement apparatus 300 (S230).

Next, the interference position detector 130 determines whether occurrence of interference has been detected in the process of S230 (S240). In a case where occurrence of interference has not been detected, the interference position detector 130 changes the similarity threshold (S250). Then, the processes of S230 and S240 are performed again. When interference is detected after the process of S210 and in S240, the presence or absence of occurrence of interference is output to the interference avoidance method determiner 140, and the process is ended.

FIG. 9 is a schematic diagram illustrating a comparison example of histograms of the wireless signal measurement apparatus 300₁ and the wireless signal measurement apparatus 300₂ illustrated in FIG. 5. There are wireless sensors 500 of another system around the wireless signal measurement apparatus 300₁, and there are wireless sensors 500 of another system around the wireless signal measurement apparatus 300₂. In such a case, interference by the wireless sensors 500 of another system is unlikely to occur in the wireless sensors 400 around the wireless signal measurement apparatus 300₂, and therefore an operation of each wireless sensor 400 around the wireless signal measurement apparatus 300₂ does not change. Therefore, there is no change in the histogram acquired from the wireless signal measurement apparatus 300₂ from the histogram stored in the monitoring result database 150, as illustrated in FIG. 9, and when Euclidean distance comparison, cosine similarity comparison, or cross comparison is performed, a high similarity is obtained.

On the other hand, the wireless sensors 400 around the wireless signal measurement apparatus 300₁ are susceptible to interference because there are the wireless sensors 500 of another system nearby, and the exposed node problem is caused in the wireless sensors 400. At that time, the wireless signal measurement apparatus 300₁ cannot receive radio waves from the wireless sensors 400 therearound, and receives radio waves from other systems relatively distant, and consequently, a period of time during which the received power is small increases. As a result, the histogram acquired from the wireless signal measurement apparatus 300₁ differs from the histogram stored in the monitoring result database 150 and the similarity decreases as illustrated in FIG. 9, and consequently, the interference position detector 130 of the interference detection apparatus 100 can determine that interference has occurred around the wireless signal measurement apparatus 300₁.

The interference detection apparatus 100 may designate, for example, pluralities of types of the number of classes and class widths regarding the histograms of the time occupancy of the received power in a designated period for transmitting the sensor information, and may notify the wireless signal measurement apparatus 300 to transmit a plurality of types of histograms. In a case where the interference detection apparatus 100 has notified the wireless signal measurement apparatus 300 to transmit the plurality of types of histograms, histograms of respective types are accumulated in the monitoring result database 150.

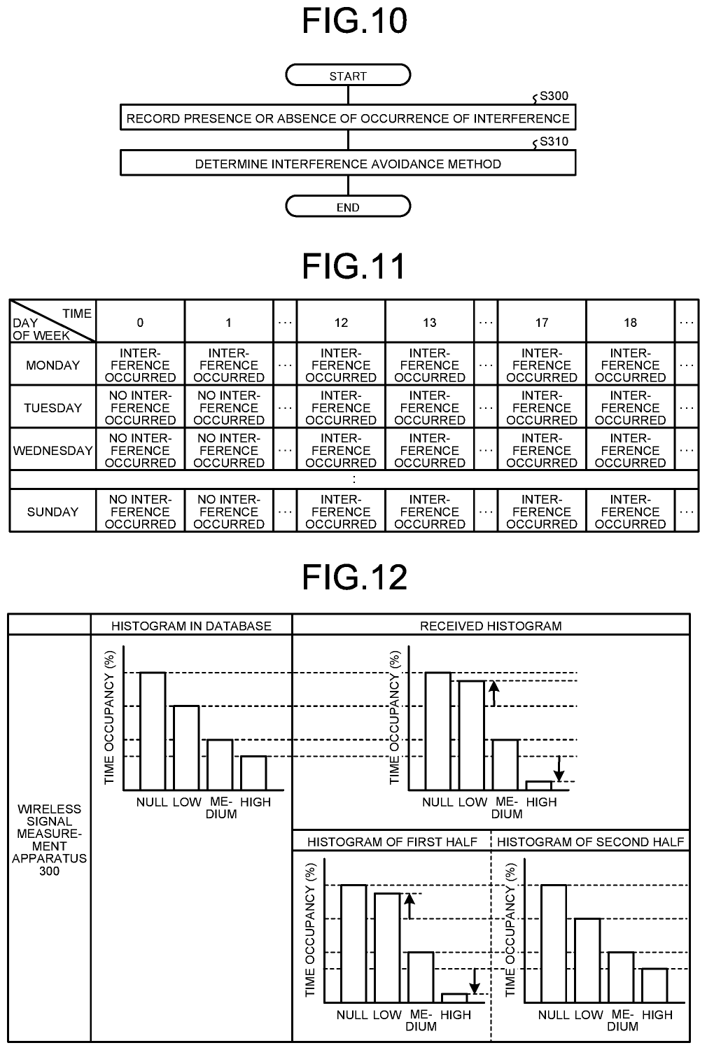

Next, an operation of the interference avoidance method decider 140 will be described. FIG. 10 is a flowchart illustrating an example of a process flow of the interference avoidance method decider 140. The interference avoidance method decider 140 notified of interference detection from the interference position detector 130 first records occurrence of interference in time series for the wireless signal measurement apparatus 300 of which interference detection has been notified (S300). Then, next, an interference avoidance method is determined on the basis of a record of the presence or absence of interference in time series that is recorded (S310).

The determined interference avoidance method is determined by the method. For example, when the wireless sensor 400 changes a sensor information transmission schedule to avoid interference, the interference detection apparatus 100 possibly notifies the target wireless sensor 400 of a result of the scheduling. Here, the target wireless sensor 400 is the wireless sensor 400 in which there exists a lack in the reception of sensor information when the interference position detector 130 detects occurrence of interference. In a case where the interference detection apparatus 100 knows a positional relationship between the wireless sensor 400 and the wireless signal measurement apparatus 300, the wireless sensor 400 around the wireless signal measurement apparatus 300 may be identified and used as a target of notification of the interference avoidance method.

FIG. 11 illustrates an example of the presence or absence of occurrence of interference recorded in time series in the interference avoidance database 160. Such a record is created corresponding to each wireless signal measurement apparatus 300. FIG. 11 is an example of a case where the wireless sensor 400 transmits sensor information every hour in a predetermined time, and the presence or absence of occurrence of interference is recorded every hour. In addition, records separated for each day of the week that is longer than one hour are also created. The separation used when recording occurrence of interference is not limited to the above example, and a plurality of types of separation may be used depending on characteristics of the wireless sensors.

When the records of the presence or absence of occurrence of interference as illustrated in FIG. 11 are created in the interference avoidance database 160, the interference avoidance method decider 140 determines to perform control such that a transmission opportunity of the wireless sensor 400 is increased (a predetermined time for the wireless sensor to transmit sensor information is prolonged) in the process of S310 in order to improve a communication success rate in a time zone in which interference has occurred. Because it is not necessary to increase the transmission opportunity in all time zones, it is expected to suppress an increase in power consumption of the wireless sensor.

The wireless signal measurement apparatus 300 may: divide the power measurement period into a plurality pieces, such as two pieces of a first half and a second half; create a histogram of each separated section; and notify the interference detection apparatus 100 of the histogram. In such a case, the interference position detector 130 of the interference detection apparatus 100 can divide the power measurement period more finely and know where in the power measurement period interference occurs, and it is possible to detect a time-series pattern of occurrence of interference in the power measurement period.

FIG. 12 illustrates examples of histograms in a case where the power measurement period is divided into two pieces. The received histogram is different from the histogram of the database over the entire period. Furthermore, when the respective histograms of the first half and the second half of the power measurement period are compared with the histogram of the database, the histogram of the first half differs from the histogram of the database while the histogram of the second half does not differ therefrom. When radio interference from other systems is concentrated in a first half of a period during which sensor information of a wireless sensor is transmitted, an event as illustrated in FIG. 12 occurs in which a difference appears in the first half and no difference appears in the second half. As described above, when changes in histograms of divided periods with respect to the histogram of the database are deviated to a specific divided period, the interference position detector 130 detects that there is a pattern in time when interference occurs. At that time, the interference position detector 130 notifies the interference avoidance method determiner 140 of not only the presence or absence of occurrence of interference but also the detected pattern in the process of S250.

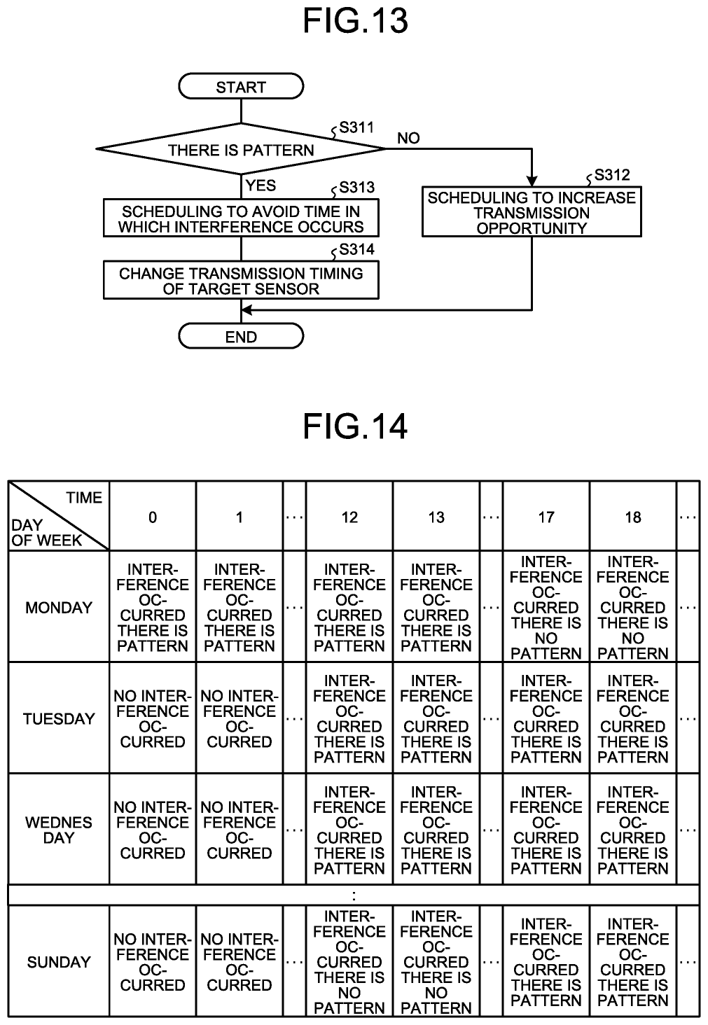

FIG. 13 is a flowchart illustrating an example of a process flow of the interference avoidance method determination process (S310) performed by the interference avoidance method determiner 140 when a pattern of occurrence of interference is detected. It is assumed that, in the process of S300, the interference avoidance method determiner 140 records not only the presence or absence of occurrence of interference but also the detected pattern of occurrence of interference in the interference avoidance database 160. The interference avoidance method determiner 140 first refers to the interference avoidance database 160 to determine whether there is a pattern in occurrence of interference (S311). When there is no pattern, the interference avoidance method determiner 140 determines to control to increase a transmission opportunity of a target wireless sensor (S312). On the other hand, when there is a pattern, the interference avoidance method determiner 140 performs scheduling so that the wireless sensor notifies sensor information in the power measurement period, while avoiding a time zone in which interference occurs (S313). Then, the interference avoidance method determiner 140 changes transmission timing so that the target wireless sensor transmits sensor information in accordance with a result of the scheduling (S314).

FIG. 14 is an example of recorded contents of the interference avoidance database 160 when there is a time-series pattern in occurrence of interference in the power measurement period. Although descriptions regarding types of patterns are omitted for simplification of the figure, it is assumed that features of the patterns are also recorded. Among the time zones in which interference occurred in FIG. 14, the processes in S313 to S314 are performed for the time zones in which there is a pattern, and the process in S312 is performed for the time zones in which there is no pattern.

A configuration can be employed in which, as described above, the interference position detector 130 of the interference detection apparatus 100 transmits a set value of the power measurement period via the wireless communication device 200 to notify the wireless signal measurement apparatus 300 of a change. In addition, a configuration can be employed in which the interference position detector 130 transmits the number of classes and the class widths of the histograms via the wireless communication device 200 to notify the wireless signal measurement apparatus 300 of a change.

As described above, according to the interference detection apparatus and the wireless signal measurement apparatus of the embodiment, the wireless signal measurement apparatus creates a histogram of time occupancy of a detected power value for a time-series power measurement result, and notifies the interference detection apparatus of the histogram. The interference detection apparatus can acquire occurrence of interference due to the exposed node problem and a time-series change on the basis of the notified histogram and a histogram received in the past. Consequently, it is possible to determine an interference avoidance method that is suitable for the time-series change in occurrence of interference. In a wireless communication system in which an installed wireless sensor performs transmission in a designated time in a very long cycle (for example, on an hourly or daily basis), the present invention is effective for detecting occurrence of interference and determining a countermeasure corresponding to the detected occurrence of interference.

### REFERENCE SIGNS LIST

100 interference detection apparatus;
110 information processor;
111 processor;
112 memory;
120 network interface;
121 network interface card (NIC);
130 interference position detector;
140 interference avoidance method determiner;
150 monitoring result database;
160 interference avoidance database;
200 wireless communication device;
210 antenna;
300, 330₁, 300₂ interference detection apparatus;
310 wireless interface;
320 received power statistics collector;
340 antenna;
341 processor;
342 memory;
343 wireless transmission-reception circuit;
400 (400₁-400₅) wireless sensor;
500 (500₁-500₅) wireless sensor.

1. An interference detection apparatus in a wireless system that comprises a plurality of wireless sensors to transmit sensor information on a common radio-frequency band wirelessly and a wireless signal measurement apparatus to measure power of a wireless signal of the radio-frequency band, the interference detection apparatus comprising:
an information processor to determine a lack in reception of the sensor information transmitted from each of the wireless sensors;
an interference position detector
to acquire, from the wireless signal measurement apparatus, a histogram that is created for a predetermined power measurement period on a basis of a result of the measurement and indicates time occupancy in the power measurement period of each of classes of classified power values, the number of which is prescribed,
to compare the acquired histogram with a histogram acquired in past, and
to detect occurrence of interference around the wireless signal measurement apparatus; and
an interference avoidance method determiner
to record occurrence of interference for each power measurement period in time series on a basis of a result of detection of occurrence of interference in the interference position detector, and
to determine an interference avoidance method on a basis of the record and a result of the detection by the information processor.

2. The interference detection apparatus according to claim 1, wherein
the histogram includes a histogram for each of periods obtained by dividing the power measurement period into periods,
the interference position detector detects occurrence of interference for each of the divided periods, and detects whether there is a time-series pattern in occurrence of interference in the power measurement period in which interference has been detected, and
when there is the time-series pattern, the interference avoidance method determiner performs scheduling for an interference avoidance method such that the sensor information is transmitted in a time zone in which interference does not occur in the power measurement period.

3. The interference detection apparatus according to claim 1, wherein
the interference avoidance method determiner performs classification in units longer than the power measurement period and keeps the record of occurrence of interference.

4. The interference detection apparatus according to claim 1, wherein
the interference position detector notifies the wireless signal measurement apparatus of one or more of the power measurement period, the number of classes of the power values, and ranges of classes of the power values.

5-6. (canceled)

7. The interference detection apparatus according to claim 2, wherein
the interference avoidance method determiner performs classification in units longer than the power measurement period and keeps the record of occurrence of interference.

8. The interference detection apparatus according to claim 2, wherein
the interference position detector notifies the wireless signal measurement apparatus of one or more of the power measurement period, the number of classes of the power values, and ranges of classes of the power values.

9. The interference detection apparatus according to claim 3, wherein
the interference position detector notifies the wireless signal measurement apparatus of one or more of the power measurement period, the number of classes of the power values, and ranges of classes of the power values.

10. The interference detection apparatus according to claim 7, wherein
the interference position detector notifies the wireless signal measurement apparatus of one or more of the power measurement period, the number of classes of the power values, and ranges of classes of the power values.
